(19) United States
(12) Patent Application Publication
(10) Pub. No.: US 2009/0047918 A1
(43) Pub. Date: Feb. 19, 2009

(54) Mix and Match Preselector and RF Receiver

(75) Inventors: Wen Jau Tai, Bayan Lapas (MY); Soon Kuan Yap, Bayan Lapas (MY); Siew Ming Kwok, Bayan Lepas (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/838,248

(22) Filed: Aug. 14, 2007

(51) Int. Cl. H04B 1/06

(52) U.S. Cl. 455/130

(57) ABSTRACT

A measuring receiver includes a preselector, spectrum analyzer and a signal source. The preselector has a filtered path for pre-filtering an input signal and outputting a pre-filtered signal. The preselector also has a bypass path for passing the input signal directly from the signal source to the spectrum analyzer. A switch switches the signal between the filtered path and the bypass path. The measuring receiver is calibrated by calibrating a bypass path of the preselector and then storing the resulting bypass path calibration data. The signal source and the spectrum analyzer are connected to the preselector. A signal from the signal source is output to the preselector and the difference between signals passing through a filtered path and bypass path are measured to produce difference measurement data. The difference measurement data is combined with the bypass calibration data to calibrate the filtered path of the preselector.

### BACKGROUND OF THE INVENTION

Any product that uses the public power grid or has electronic circuitry must pass EMC (electromagnetic compatibility) requirements. EMC is essentially the opposite of EMI (electromagnetic interference). EMC means that the device is compatible with (i.e., no interference caused by) its EM environment, and it does not emit levels of electromagnetic energy that cause EMI in other devices in the vicinity. Compliance with these emission requirements requires radiated emissions testing and conducted emissions testing. EMI receivers are used to measure the characteristics of these products to make sure that they meet the emissions requirements.

Herein “measurement receiver” or “measuring receiver” is defined as a system used to examine the spectral composition of some electrical, acoustic, or optical waveform. EMI receivers are thus a subset of “measuring receivers”.

Radiated emissions testing looks for signals being emitted from the equipment under test (EUT) through space. The typical frequency range for these measurements is 30 MHz to 1 GHz, although FCC regulations require testing up to 200 GHz for an intentional radiator (such as a wireless transmitter) operating at a center frequency above 30 GHz.

Conducted emissions testing focuses on signals present on the AC mains that are generated by the EUT and these signals are usually below 30 MHz.

The CISPR frequency bands include the conducted band (“C Band”) and the radiated band (“R Band”). The radiated emissions testing is performed in the “R Band” and conducted emissions testing is performed in the “C Band”. Within the “C Band” is the “Band A” covering 9 kHz to 150 kHz and the “Band B” covering 150 kHz to 30 MHz. Within the “R Band” is the “Band C” covering 30 MHz to 300 MHz and the “Band D” covering 300 MHz to 1 GHz.

Industry standards for EMC conformance testing include CISPR, EN, FCC, VCCI, and VDE.

In order to make compliance EMC measurements, the EMI receiver must meet the requirements of CISPR publication 16 (CISPR 16) entitled “CISPR specification for radio interference measuring”. An example of a prior art EMI receiver having the characteristics recommended in CISPR 16 is the Agilent 8566B Spectrum Analyzer combined with the Agilent 85685A RF preselector and the Agilent 85650A quasi-peak adapter. The preselector adds tracking filters and preamplifiers to the spectrum analyzer to provide an EMI receiver that is sensitive to low-level signals while providing overload protection from out-of-band signals. This EMI receiver has the characteristics recommended in CISPR publication 16 and is described in more detail in the publication “Agilent RF Preselector, 20 Hz to 2 GHz, For the 8566B or 8568B Spectrum Analyzer, Data Sheet” from Agilent Technologies, Inc. of Santa Clara, Calif., USA.

Previously, to meet CISPR requirements, a particular preselector could only be paired with a particular spectrum analyzer after they had been calibrated together in the factory as an EMI receiver system. Thus, for example, if a particular preselector “A” were calibrated and shipped together with a particular spectrum analyzer “A”, then they could only be used in this particular combination in order to meet compliance specifications. The preselector “A” could not be used with a spectrum analyzer “B”, and a preselector “B” could not be used with the spectrum analyzer “A”. If these new pairings were desired, then the new pair (“A” with “B”) needed to be sent back for re-calibration in order to meet compliance specifications.

This off-site solution creates inflexibility for the users. They are unable to simply interchange the instruments on-site and proceed with their measurements. This is especially true when one of the instruments has become defective.

It would be desirable to provide a “mix and match” solution that would allow for different preselectors and spectrum analyzers to be paired together as an EMI receiver, without the need to return the components to the factory or to a service site to be calibrated together.

### SUMMARY OF THE INVENTION

The present invention provides a “mix and match” solution that allows different preselectors and spectrum analyzers to be paired together as an EMI receiver, without the need to return the components to the factory or to a service site to be calibrated together.

In more general terms the invention is a measuring receiver which includes a preselector, spectrum analyzer and a signal source. The preselector has an input port for receiving an input signal from the signal source and an output port for outputting a signal to the spectrum analyzer. The preselector has a filtered path for pre-filtering the input signal and outputting a pre-filtered signal through the output port. The preselector also has a bypass path for passing the input signal directly to the spectrum analyzer to the output port to measure bypass path calibration data. A switch switches the signal between the filtered path and the bypass path to determine a difference between the filtered path calibration data and bypass path calibration data.

The measuring receiver is calibrated by calibrating the bypass path of the preselector to produce bypass path calibration data, storing the bypass path calibration data, electrically connecting the signal source and the spectrum analyzer to the preselector, outputting a signal from the signal source into the preselector, measuring the difference between signals passing through a filtered path of the preselector and a bypass path of the preselector to produce difference measurement data, and combining the difference measurement data with the bypass calibration data to calibrate the filtered path of the preselector.

### BRIEF DESCRIPTION OF THE DRAWINGS

Further preferred features of the invention will now be described for the sake of example only with reference to the following figure, in which:

FIG. 1 shows components making up a CISPR compliant EMI receiver of an embodiment of the present invention.

FIG. 2 shows a schematic block diagram of the preselector of FIG. 1.

FIG. 3 shows the schematic block diagram of FIG. 2 with a radiated emissions RF filter path highlighted.

FIG. 4 shows the schematic block diagram of FIG. 2 with a conducted emissions RF filter path highlighted.

FIG. 5 shows the schematic block diagram of FIG. 2 with an RF bypass path highlighted.

FIG. 6 is a system level block diagram showing the control components for controlling the preselector of FIGS. 1-5. Also shown is the DLP loaded onto a spectrum analyzer for controlling the preselector.

FIG. 7 is a general schematic diagram of the signal path losses introduced by the preselector used to describe the calibration of the EMI receiver of FIG. 1.

FIGS. 8A and 8B show the method for calibrating the EMI receiver of FIGS. 1-7.

### DETAILED DESCRIPTION

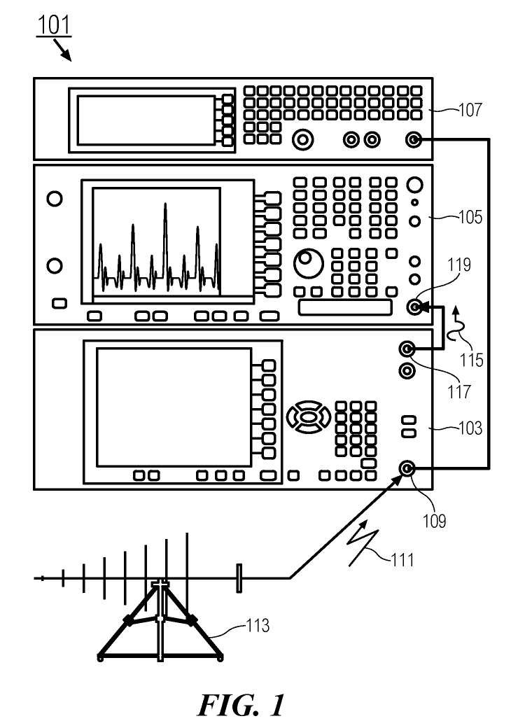

FIG. 1 shows components making up a CISPR 16 compliant EMI receiver 101 of the present invention. The components include a preselector 103, a spectrum analyzer 105, and a signal source 107. In general the spectrum analyzer 105 can be selected from different types of signal analyzers and the EMI receiver 101 can be selected from different types of measurement receivers.

The components can be combined to create a “mix and match” solution that allows different preselectors and spectrum analyzers to be paired together as the EMI receiver 101, without the need to return the components to the factory or to a service site to be calibrated together. Instead, the components including the preselector 103, the spectrum analyzer 105, and the signal source 107 are calibrated separately according to their own calibration cycles and according to their own individual specification guides. Then, the components are connected together at the user's location and calibrated together using a user alignment routine. Thus, as long as separate preselectors 103, spectrum analyzers 105, and signal sources 107 are calibrated separately, they can be combined together as a “mix and match” EMI receiver solution.

This “mix and match” ability is particularly useful when, at a user's location, a preselector and a spectrum analyzer are paired together as an EMI receiver and one of them becomes defective. The user can replace the defective preselector or spectrum analyzer with a properly functioning one and continue using the EMI receiver without needing to send the paired spectrum analyzer and preselector to the factory or to a service site to be recalibrated together. This can save much time and prevent lost productivity.

More generally, if a particular preselector “A” is calibrated and shipped together with a particular spectrum analyzer “A”, then, as in the prior art, they can be used in this particular combination in order to meet compliance specifications. Moreover, using the present invention at the user's location, the preselector “A” can be matched with a different spectrum analyzer “B” and the user alignment routine can be performed at the user's location resulting in an EMI receiver meeting compliance specifications. Also, at the user's location, a different preselector “B” can be matched with the spectrum analyzer “A” resulting in an EMI receiver meeting compliance specifications. If these new pairings are desired, the new pair need not be sent back for re-calibration in order to meet compliance specifications, but rather the user alignment is performed at the user's location. All of these different pairing combinations will meet compliance standards such as CISPR requirements.

The preselector 103 pre-filters broadband signals so that the combination of the preselector 103 and spectrum analyzer 105 becomes an EMI receiver 101 for measuring impulsive EMI signals with high dynamic range and accuracy, as specified by CISPR 16. In the operation of the EMI receiver 101, a radiated or conducted emissions signal 111 to be measured is transmitted from a source 113 to a preselector RF input port 109 of the preselector 103. The source 113 can be an antenna receiving radiated emission signals, for example, or can be a cable transmitting conducted emission signals. The preselector 103 prevents the compression of the input mixer of the spectrum analyzer 105 which can be caused by broadband, impulsive emissions signals 111. The preselector 103 can be an N9039A RF preselector from Agilent Technologies, Inc. of Santa Clara, Calif., USA.

A signal 115 is output from a preselector RF output port 117 of the preselector 103 to a spectrum analyzer RF input port 119 of the spectrum analyzer 105. The spectrum analyzer can be selected from one of the PSA Series Spectrum Analyzers from Agilent Technologies, Inc. For example, the spectrum analyzer can be an E4448A PSA Series Spectrum Analyzer from Agilent Technologies, Inc. The PSA type spectrum analyzer provides the EMI receiver with broad dynamic range, accuracy and speed.

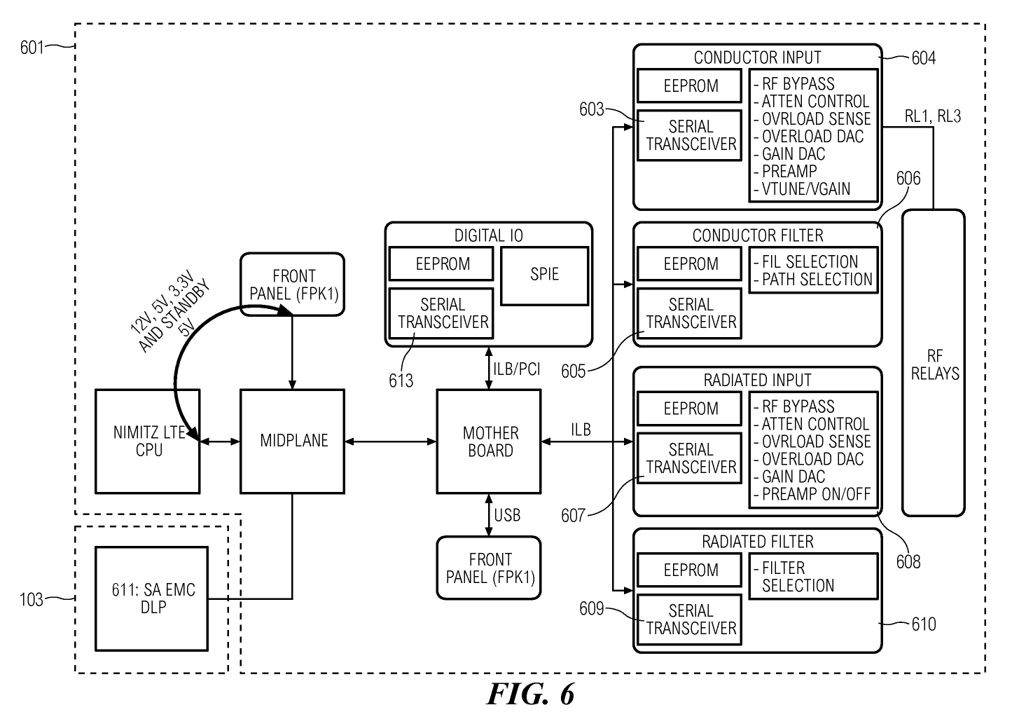

The spectrum analyzer 103 is loaded with EMC DLP software 611 (see FIG. 6). The DLP , or “Downloadable Personality”, customizes the character of the spectrum analyzer to enable software features in addition to the basic functions of the spectrum analyzer. In the present invention, the DLP software 611 adds capabilities to the Spectrum Analyzer to control and make EMC measurements using the preselector 103.

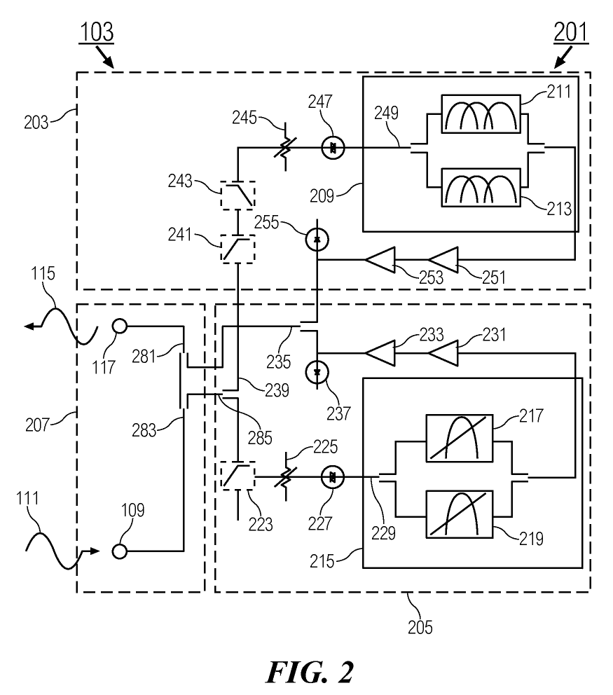

FIG. 2 shows a schematic block diagram 201 of the preselector 103 of FIG. 1. The preselector 103 includes a conducted input section 203, a radiated input section 205 and a relay switch section 207.

The conducted input section 203 processes conducted emissions signals 111 in the “C Band” (9 kHz to 30 MHz). The conducted input section 203 can comprise components mounted on and connections made on a PCB (PC board). A conducted filter section 209 includes a path through a “Band A” (9 kHz to 150 kHz) filter bank 211 and a path through a “Band B” (150 kHz to 30 MHz) filter bank 213. Each of these filter banks can include many individual filters. For example, the “Band B” filter bank 213 can have a filter for 150 kHz to 1 MHz, another filter for 1 MHz to 2 MHz, yet another filter for 2 MHz to 5 MHz and so on until 30 MHz. All these filters combined cover the 150 kHz to 30 MHz frequency range for “Band B” filter bank 213. These filters can be either analog or digital filters.

The radiated input section 205 processes radiated emissions signals 111 in the “R Band” (30 MHz to 1 GHz). The radiated input section 205 can comprise components mounted on and connections made on a PCB (PC board). A radiated filter section 215 includes a path through a “Band C” (30 MHz to 300 MHz) filter bank 217 and a path through a “Band D” (300 MHz to 1 GHz) filter bank 219. Again, each of these filter banks can include many individual filters and these filters can be either analog or digital filters.

The relay switch section 207 is shown in FIG. 2. The relay switch section 207 provides switching between several different paths through the preselector 103. The relay switch section 207 can include switches 281, 283 and can be implemented using an 8763C (4 RF Port) microswitch.

The EMI receiver 101 has three modes of operation: a radiated emissions mode, a conducted emissions mode, and a bypass mode.

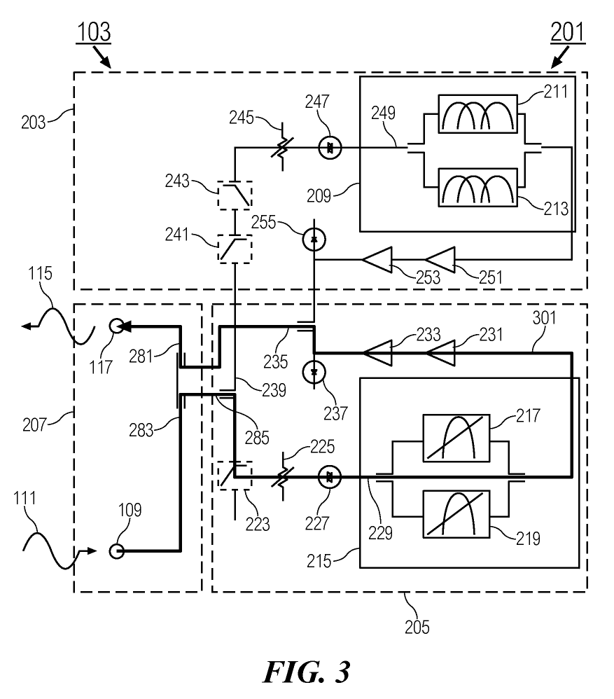

When measuring a radiated emissions signal 111 the radiated emissions mode is used. The switches 281, 283 are positioned such that a radiated emissions RF filter path 301 of FIG. 3 is switched in, providing a path from the preselector RF input port 109 into the radiated input section 205. For the case of the radiated emissions signal 111, a switch 285 is positioned such that the radiated emissions signal 111 passes through the radiated input section 205 along the “R Band” radiated emissions RF filter path 301.

The “R Band” signal 111 is above 30 MHz (30 MHz to 1 GHz) so a 30 MHz high pass filter 223 is used to filter out any low frequency noise. Next, a rugged RF input or step attenuator 225 and a limiter 227 provide input protection against large pulsed signals or other gross overloads that could damage the input attenuator or the first mixer of the spectrum analyzer 105.

The “R Band” signal 111 then enters the radiated filter section 215. A switch 229 is positioned to send the signal 111 through the tunable filter bank 217 when the signal 111 is within the “Band C” (30 MHz to 300 MHz) and the switch 229 is positioned to send the signal 111 through the tunable filter bank 219 when the signal 111 is within the “Band D” (300 MHz to 1 GHz). The preselection filters of the filter banks 217, 219 reduce the energy content of the broadband signal that the mixer of the spectrum analyzer 105 sees. This improves the dynamic range compared to using the spectrum analyzer 105 alone and allows the measurement of small signals in the presence of large ambient signals that would otherwise overload the front end of the spectrum analyzer 105. These large ambient signals are particularly a problem when trying to measure low level radiated emissions at an outdoor site where there are often many high power radio transmitters in the area.

The “R Band” signal 111 then passes through a variable gain amplifier 231 and a step gain amplifier 233. These low noise pre-amplifiers improve the system noise performance and give better sensitivity to the combined preselector 103 and spectrum analyzer 105 than the spectrum analyzer 105 used alone.

After passing from the amplifiers 231, 233, but before passing through a switch 235 and out of the radiated input section 205, the signal 111 passes through an overload detector 237. If the signal level is too large, the overload detector 237 will send a trigger to an overload status register of the preselector digital control components 601. The EMC DLP software 611 queries the overload status register and upon determining there has been an overload occurrence it will display an error message on the display of the spectrum analyzer 105. This display alerts an end user that an overload condition has occurred.

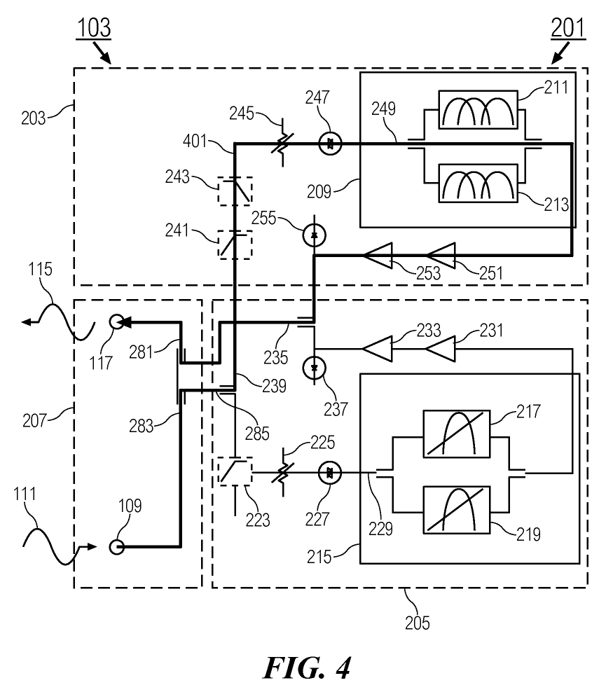

When measuring a conducted emissions signal 111 the conducted emissions mode is used. The switches 281, 283, are positioned such that a conducted emissions RF filter path 401 of FIG. 4 is switched in, providing a path from the preselector RF input port 109 into the radiated input section 205. For the case of a conducted emissions signal 111, the switch 285 is positioned such that the conducted emissions signal 111 passes along an unfiltered “C Band” path 239 of the radiated input section 205, out from the radiated input section 205, into the conducted input section 203, and back into the radiated input section 205.

The “C Band” signal 111 is between 9 kHz and 30 MHz, and so a 9 kHz high pass filter 241 and a 30 MHz low pass filter 243 are used to filter out any out-of-band noise. Next, a rugged RF input or step attenuator 245 and a limiter 247 provide input protection against large pulsed signals or other gross overloads that could damage the input attenuator or the first mixer of the spectrum analyzer 105. This protection is especially important when making conducted emissions measurements using a current clamp or LISN (Line Impedance Stabilization Network), which can generate voltage spikes of several hundred volts.

The “C Band” signal 111 then enters the conducted filter section 209. A switch 249 is positioned to send the signal 111 through the fixed filter bank 2 11 or the fixed filter bank 213, depending on the frequency range of the signal 111. For example, when the signal 111 is within the “Band A” (9 kHz to 150 kHz) and the switch 249 is positioned to send the signal 111 through the fixed filter bank 211. When the signal 111 is within the “Band B” (150 kHz to 30 MHz), the switch 249 is positioned to send the signal 111 through the fixed filter bank 213.

The preselection filters of the filter banks 211, 213 reduce the energy content of the broadband signal that the mixer of the spectrum analyzer 105 sees. This improves the dynamic range compared to using the spectrum analyzer 105 alone and allows for the measurement of small signals in the presence of large ambient signals that would otherwise overload the front end of the spectrum analyzer 105.

The “C Band” signal 111 then passes through a variable gain amplifier 251 and a step gain amplifier 253. These low noise pre-amplifiers improve the system noise performance and give the preselector 103 and spectrum analyzer 105 combination better sensitivity than the spectrum analyzer 105 used alone.

Before leaving the conducted input section 203, the signal 111 passes through an overload detector 255. If the signal level is too large, the overload detector 255 will send a trigger to an overload status register of the preselector digital control components 601. The EMC DLP software 611 queries the overload status register and upon determining there has been an overload occurrence it will display an error message on the display of the spectrum analyzer 105. This display alerts an end user that an overload condition has occurred.

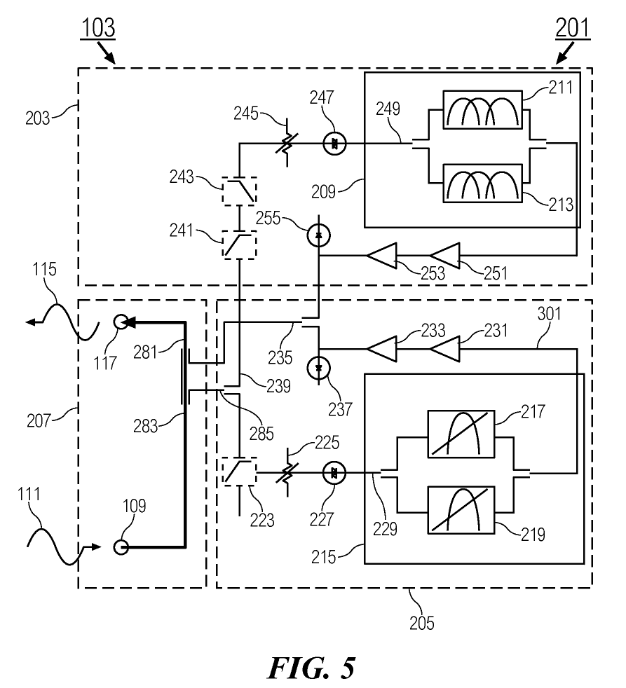

An RF bypass path 501 (see FIG. 5) is switched in by the relay switch section 207, providing a path directly from the preselector RF input port 109 to the preselector RF output port 117 without passing through the conducted or radiated input sections 203, 205. The RF bypass path 501 is used when making EMI measurements to perform fast prescans of the input signal 111 using the bypass mode of the preselector 103. For those emissions in question, the user switches to the preselected mode through the paths 301 or 401, with the press of a button. The use of the RF bypass path 501 for calibrating the EMI receiver 101 system is unique to the preselector 103 of the present invention. Calibrating this path during a “factory calibration” allows for calibration of the EMI receiver 101 system at the site of the “end user” rather than using a “factory calibration” (described in more detail below).

FIG. 6 is a system level block diagram showing the preselector digital control components 601 for controlling the preselector 103. Serial transceiver CPLDs (Complex Programmable Logic Devices) 603, 605, 607, 609 communicate with a serial transceiver CPLD 613. Also shown is the DLP 611 loaded into the spectrum analyzer 105 for controlling the preselector 103.

The controls for the conducted input section 203 are provided by the serial transceiver 603 of conductor input control logic 604. The serial transceiver 603 provides control of the step attenuator 245, input switch control signals to control the relay switch section 207, overload voltage threshold DAC number, overload sense to acquire the signal from the overload detector 255, tuning of DAC numbers, fine gain DAC number and on/off control of the variable gain and step gain preamplifiers 251, 253.

The controls for the conducted filter section 209 are provided by the serial transceiver 605 of conductor filter control logic 606. The serial transceiver 605 provides control of the filter selection between the filter banks 211, 213 and provides on-board relay switch control signals to control the switch 249.

The controls for the radiated input section 205 are provided by the serial transceiver 607 of radiated input control logic 608. The serial transceiver 607 provides control of the step attenuator 225, on-board relay switch control signals to control the switch 285, course gain signals controlling the step gain of the amplifier 233 and variable gain of the amplifier 231, overload voltage threshold DAC number, overload sense to acquire the signal from the overload detector 237 and on/off control of the preamplifiers 231, 233.

The controls for the radiated filter board 215 are provided by a serial transceiver 609 of radiated filter control logic 601. The serial transceiver 609 provides control of the filter selection between the filter banks 217, 219 and, on-board relay switch control signals to control the switch 229.

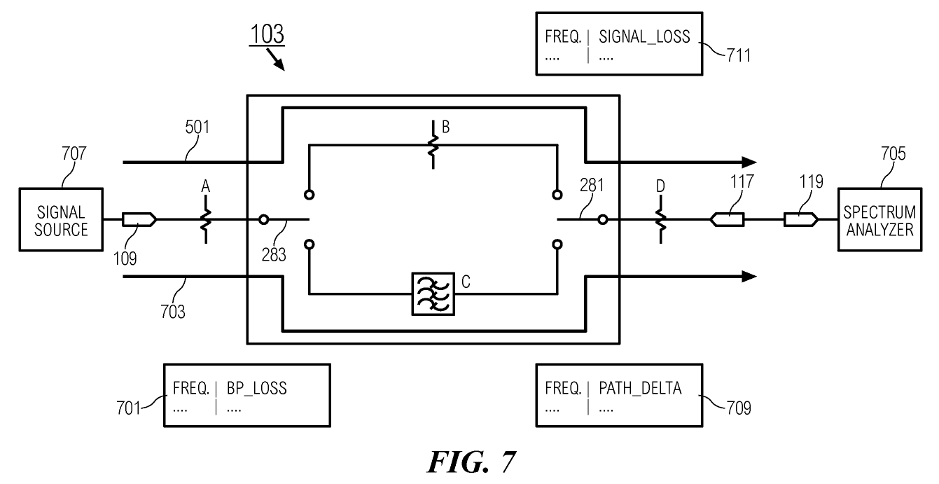

FIG. 7 is a general schematic diagram of the signal path losses introduced by the preselector 103, and is used to describe the calibration of the EMI receiver 101 of the present invention. The RF bypass path 501 of FIG. 5 and a preselector path 703 (which can be either the radiated emissions RF filter path 301 in FIG. 3 or the conducted emissions RF filter path 401 in FIG. 4, depending on the frequency band) are shown. The signal is provided to the preselector RF input port 109 by a signal source 707 and is measured at the preselector RF output port 117 by a spectrum analyzer 705.

The bypass loss of the RF bypass path 501 from the preselector RF input port 109 to the preselector RF output port 117 is the sum of the losses A, B and D:

BP_Loss=A+B+D.

The losses “A”, “B”, and “D” are losses through the relay switch section 207 (FIG. 2). “A” includes the losses of the path from the RF input port 109 to the switch 283. “B” includes the losses of the path from the switch 283 to the switch 281. “D” includes the losses of the path from switch 281 to the RF output port 117.

The loss through the preselector path 703 from the preselector RF input port 109 to the preselector RF output port 117 (“Preselector_Loss”) is the sum of the losses A, C and D:

Preselector_Loss=A +C +D.

The loss “C” is the loss through the conducted input section 203 and the radiated input section 205 (FIG. 2).

Presently, in the field of electronic test and measurement equipment calibration, time consuming, complicated, or high-accuracy equipment calibrations are often more conveniently performed at manufacturing or customer service centers than at the site of the “end user”. This type of manufacturing or customer service center calibration can be referred to as “factory calibration”. The factory calibration site will generally have more accurate (and more costly) equipment available to it than an end user would have. In the context of the present invention, an “end user” would generally not be the manufacturer of the EMI receiver 10 1, but rather would be a person or business which performs EMI measurements with the EMI receiver 101 to verify that a product or service meets CISPR or other EMI measurement standards.

The separate components making up the EMI receiver 101, including the preselector 103, spectrum analyzer 105, and signal source 107, can be calibrated separately very accurately, according to their own calibration cycles and according to their own individual specification guides, at the factory calibration site to generate a set of calibration data for each, which is not altered again until the next calibration cycle.

In one embodiment of the present invention, the EMI receiver 101 achieves a total measurement accuracy of ±1 dB or greater. This requires a calibration accuracy for the assembled EMI receiver 101 system that is not achievable by separate factory calibration of the components and which would be difficult for an end user to achieve. If not for the present invention, the assembled EMI receiver 101 system, including the preselector 103, spectrum analyzer 105, and signal source 107, would have to undergo the “factory calibration” to achieve this desired total accuracy.

The present invention solves this problem by combining a separate very accurate “factory calibration” of the preselector 103, with a later faster calibration, using less accurate equipment, of the assembled EMI receiver 101 system by the end user which is called a “user alignment”.

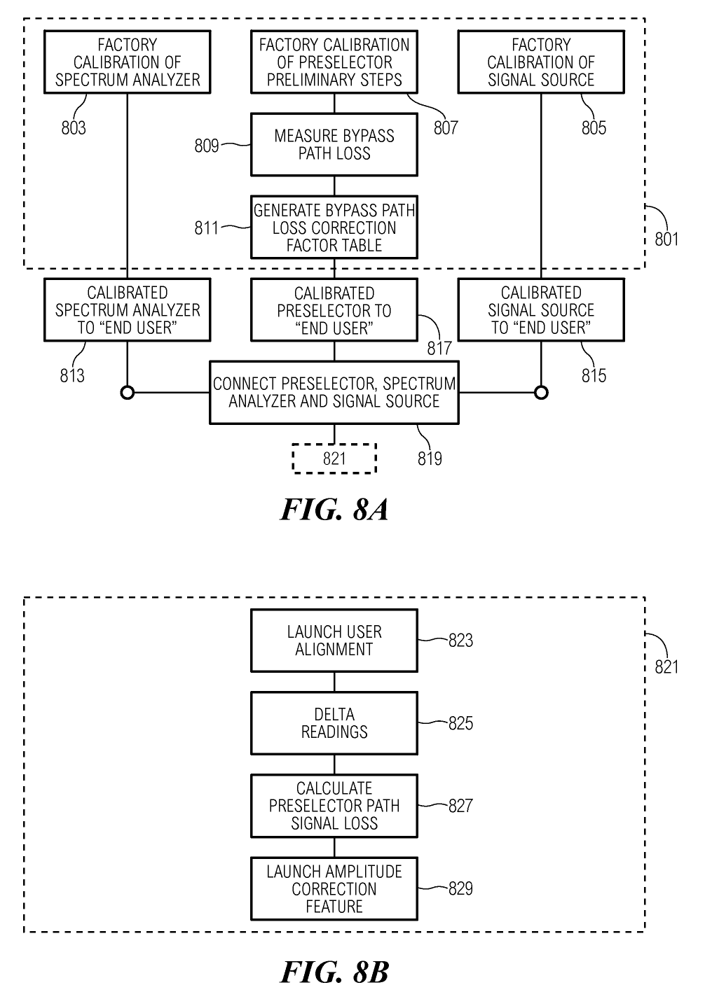

FIGS. 8A and 8B show the method for calibrating the EMI receiver 101.

FIG. 8A shows the steps of a factory calibration 801, transportation steps 813, 815, 817, and connection steps 819. Factory calibration 801 is performed separately on the components making up the EMI receiver 101, including the preselector 103, the spectrum analyzer 105, and the signal source 107. The separate factory calibrations are done for parameters of the components that do not vary much (stay within the “error budget”) over time and environment. Also, as described above, the separate calibrations are done when the particular calibration requires equipment that would not be easily available at the end user's site, or are done when the calibrations might be too time consuming for the end user to perform.

Factory calibration of the spectrum analyzer 105 is performed at STEP 803 as is already known in the art. The factory calibration is performed for amplitude accuracy from the spectrum analyzer RF input port 119 shown in FIGS. 1 and 7. However, connection of the preselector 103 to the spectrum analyzer 105 shifts the input plane of the calibrated spectrum analyzer 105 from the spectrum analyzer RF input port 119 to the preselector RF input port 109 also shown in FIGS. 1 and 7. Therefore, the assembled EMI receiver 101 system including the preselector 103, spectrum analyzer 105, and signal source 107 needs to be calibrated together.

Factory calibration of the signal source 107 is performed at STEP 805 as is already known in the art.

The factory calibration of the preselector 103 is unique for the present invention. At STEP 807 the signal source 707 is attached to the preselector RF input port 109 and the spectrum analyzer 705 to the preselector RF output port 117. The signal source 707 and the spectrum analyzer 705 are located at the factory calibration site and are generally not the same signal source 107 and spectrum analyzer 105 which are used with the preselector 103 at the site of the user. Also at STEP 807, several preliminary steps of the preselector 103 factory calibration are performed. EMI firmware is downloaded into the preselector 103. Also, memory initialization is performed by loading the serial and model number of the preselector 103. Then, default calibration data of the preselector is reloaded.

At STEP 809 the switches 281, 283 are positioned so that signals from the signal source 707 will pass through the RF bypass path 501 to the spectrum analyzer 705. The signal source 707 can be swept from DC to 26.5 GHz to characterize the RF bypass path 501 losses over this frequency range. This measurement provides the bypass loss described above, with reference to FIG. 7, as:

BP_Loss=A+B+D.

At STEP 811 the measured bypass loss (BP_Loss) of the RF bypass path 501 is used to generate an RF bypass path loss correction factor table 701 (FIG. 7). This table of correction factors is within a calibration file structure of the preselector 103 and can include frequency-amplitude pairs characterizing the RF bypass path 501 losses for frequencies from DC to 26.5 GHz. Although the preselector path 703 is only used up to 1.0 GHz, less accurate measurements can be made up to 26.0 GHz by passing the input signal 111 directly from 109 to 117 using the RF bypass path 501 in the bypass mode. When using the bypass mode, signals will not be limited by the frequency range of the radiated emissions mode and conducted emissions mode. Thus, the RF bypass path 501 losses can be characterized for frequencies from DC to 26.5 GHz if it is desired to make measurements using the RF bypass path 501 over this range.

The computations for constructing this table 701 can be performed by software within an attached personal computer or else by firmware or software within the spectrum analyzer 705 or the preselector 103, for example. Also, rather than storing the table 701 within the preselector 103, it can be stored in any external storage such as that of a magnetic storage media or a solid state memory.

Calibrating the RF bypass path 501 during a “factory calibration” allows for calibration of the assembled EMI receiver 101 system at the site of the “end user” rather than requiring a “factory calibration” of the entire assembled EMI receiver 101 system.

At Step 813 the calibrated spectrum analyzer 105 is transported from the factory calibration site and received by the “end user”. At Step 815 the calibrated signal source 107 is transported from the factory calibration site and received by the “end user”. At Step 817 the calibrated preselector 103 is transported from the factory calibration site and received by the “end user”.

These transportation steps 813, 815, 817 can be performed at very different times from each other so long as the “end user” ends up with a calibrated spectrum analyzer 105, a calibrated signal source 107, and a calibrated preselector 103 for connecting at Step 819 to obtain a CISPR 16 compliant EMI receiver 101 after the user alignment routine is run.

At Step 819 the signal source 107 is connected to the preselector RF input port 109 as shown in FIG. 1. The signal source 107 can have a frequency range from 100 kHz to 1 GHz to cover the frequency range for this particular EMI test setup. The spectrum analyzer 105 is connected to the preselector RF output port 117.

FIG. 8B illustrates the steps for running the user alignment routine 821 on the EMI receiver 101 system to adjust for amplitude accuracy and to calibrate the assembled EMI receiver. For the user alignment routine 821, the signal source 707 illustrated in FIG. 7 would be the end user's signal source 107 of FIG. 1. Also, the spectrum analyzer 705 would be the end user's spectrum analyzer 105 of FIG. 1. The user alignment routine 821 is repeated periodically or over a certain temperature drift of the system to assure that the amplitude accuracy of the EMI receiver 101 is maintained (a total required measurement accuracy of ±1 dB or greater in some embodiments). It typically takes no more than 30 minutes to perform the full user alignment routine.

At a user alignment launching Step 823, the user alignment routine is launched by a button push on an instrument keypad of the spectrum analyzer 105 or the preselector 103. Alternatively, the user alignment can be launched remotely by a remote command received over a network.

At a “delta reading” step 825 of the user alignment routine, the signal source 107 is swept from 100 kHz to 1 GHz. At each frequency, the switches are changed between their preselector path 703 positions and their RF bypass path 501 positions. The spectrum analyzer 105 detects the outputs at each frequency at the preselector RF output port 117. The difference between the signal loss through the preselector path 703 (which can be either the path 301 in FIG. 3 or the path 401 in FIG. 4) and through the RF bypass path 501 is measured by the spectrum analyzer 105 at each frequency (providing measured “delta readings”). These delta reading measurements are used to provide a very accurate calibration of the assembled EMI receiver 101 based on the following calculations.

The absolute loss through the RF bypass path 501 during “user alignment” from the preselector RF input port 109 to the preselector RF output port 117 (“BP_Loss”) is:

BP_Loss=A+B+D

Where the losses A, B and D are as described above with reference to the factory calibration 803.

The absolute loss through the preselector path 703 during “user alignment” from the preselector RF input port 109 to the preselector RF output port 117 (“Preselector_Loss”) is:

Preselector_Loss=A+C+D,

where the losses “A” and “D” are as described above and the loss “C” is the is the loss through the conducted input section 203 and the radiated input section 205 (FIG. 2).

Thus, the measurement of the “delta readings” represents:

Path-Delta=Preselector_Loss−BP Loss=(A+C+D)−(A+B+D)=C−B

So there is no need for the end user to measure the absolute loss through the RF bypass path 501 or the absolute loss through the preselector path 703. Rather, the difference between the loss of these two paths is measured to provide a “delta reading” which is a relative measurement. Thus, the spectrum analyzer 105 and the signal source 107 used during the user alignment do not need to be very accurate.

At Step 827 the “delta readings” (C−B) determined at Step 825 are combined with the RF bypass path loss correction factor table 701 (A+B+D) determined from the preselector factory calibration 807 to determine the total loss (A+C+D) of the preselector path 703 from the preselector RF input port 109 to the preselector RF output port 117 as shown by:

Signal_Loss=BP_Loss+Path_Delta=(A+B+D)+(C−B)=A+C+D.

In executing the above calculation, the “delta readings” can first be stored in a “delta readings” correction factor table 709 (see FIG. 7) of frequency-amplitude pairs and then this table 709 can be combined with the stored RF bypass path loss correction factor table 701. Alternatively, the “delta readings” can be directly combined with the elements of the RF bypass path loss correction factor table 701 without organizing them into the intermediate table 709. In either case the result is a very accurate preselector path correction factor table 711.

Thus, relative “delta readings” data is combined with the very accurate factory calibrated absolute RF bypass path loss correction factor table 701 to generate the very accurate preselector path correction factor table 711 for correcting the losses (Signal_Loss) of the preselector path 703.

The computations for constructing these tables 709, 711 of frequency-amplitude pair correction factors can be performed by software within an attached personal computer or else by firmware or software within the spectrum analyzer 105 or the preselector 103, for example. The tables 709, 711 can be stored within the preselector 103, spectrum analyzer 105 or can be stored in any external storage such as a magnetic storage media or a solid state memory.

At Step 829 an amplitude correction feature of the spectrum analyzer 105 uses the preselector path correction factor table 711 to compensate for the amplitude errors introduced by attaching the preselector 103 in front of the spectrum analyzer 105.

In the foregoing specification, the invention has been described with reference to specific exemplary embodiments thereof. The specification and drawings are, accordingly, to be regarded in an illustrative sense rather than a restrictive sense.

1. A preselector of a measuring receiver comprising:
an input port for receiving an input signal from a signal source;
an output port;
a filtered path for pre-filtering the input signal and outputting the pre-filtered input signal to the output port to measure filtered path calibration data;
a bypass path for passing the input signal to the output port to measure bypass path calibration data; and
a switch for switching the signal between the filtered path and the bypass path to determine a difference between the filtered path calibration data and bypass path calibration data.

2. The preselector of claim 1 further comprising stored bypass path calibration data representing the absolute loss of the bypass path.

3. The preselector of claim 2 wherein the stored bypass path calibration data is stored as frequency-amplitude pairs in a calibration file structure.

4. The preselector of claim 1, wherein the filtered path includes a conducted path for measuring conducted emissions, a radiated path for measuring radiated emissions, and a switch for switching between the conducted path and radiated path.

5. A measuring receiver incorporating the preselector of claim 1 comprising the preselector, a spectrum analyzer and a signal source.

6. The measuring receiver of claim 5, wherein the measured filtered path calibration data and bypass path calibration data is measured by the spectrum analyzer.

7. The measuring receiver of claim 5, wherein the measuring receiver is an EMI receiver.

8. The measuring receiver of claim 7, wherein the EMI receiver has a measurement accuracy of at least ±1 dB.

9. The measuring receiver of claim 5, wherein the filtered path and the bypass path provide output signals through the output port to the spectrum analyzer.

10. The measuring receiver of claim 5, wherein the preselector and spectrum analyzer are enclosed in separate housings attachable to each other by cables.

11. The measuring receiver of claim 5, wherein the preselector stores bypass path calibration data representing the absolute loss of the bypass path.

12. The measuring receiver of claim 11, wherein the spectrum analyzer further comprises storage media storing code for performing the steps of:
measuring the difference between signals passing through the filtered path of the preselector and the bypass path of the preselector to produce difference measurement data; and
combining the difference measurement data with the bypass calibration data to calibrate the filtered path of the preselector.

13. The measuring receiver of claim 5, further comprising:
a first memory area for storing the bypass path calibration data representing the absolute loss of the bypass path;
a second memory area for storing difference measurement data of a difference between signals passing through the filtered path of the preselector and the bypass path of the preselector;
a processor for combining the difference measurement data with the bypass path calibration data to provide a preselector path correction factor table for correcting for losses of the preselector path;
a third memory area for storing the preselector path correction factor table; and
an input device for starting the calibration of the measuring receiver using the preselector path correction factor table.

14. A method for calibrating a measuring receiver made up of a preselector, a signal source and a spectrum analyzer, comprising the steps of:
calibrating a bypass path of the preselector to produce bypass path calibration data;
storing the bypass path calibration data;
electrically connecting the signal source and the spectrum analyzer to the preselector;
outputting a signal from the signal source into the preselector;
measuring the difference between signals passing through a filtered path of the preselector and a bypass path of the preselector to produce difference measurement data; and
combining the difference measurement data with the bypass calibration data to calibrate the filtered path of the preselector.

15. The method of claim 14, wherein:
the step of calibrating a bypass path of the preselector to produce bypass path calibration data is performed during a factory calibration, and
the step of measuring the difference between signals passing through a filtered path of the preselector and a bypass path of the preselector is performed at the site of an end user.

16. The method of claim 14, wherein:
a first spectrum analyzer and a first signal source are electrically connected to the preselector to perform the step of calibrating a bypass path of the preselector to produce bypass path calibration data, and
a second spectrum analyzer and a second signal source different than the first spectrum analyzer and the first signal source are electrically connected to the preselector to perform the step of measuring the difference between signals passing through a filtered path of the preselector and a bypass path of the preselector.

17. The method of claim 14, wherein the step of storing the bypass path calibration data comprises storing the bypass path calibration data in memory of the preselector.

18. The method of claim 14, wherein the step of measuring the difference between signals passing through a filtered path of the preselector and a bypass path of the preselector is performed by a processor of the spectrum analyzer.

19. The method of claim 14, wherein the steps of calibrating the bypass path of the preselector to produce bypass path calibration data, storing the bypass path calibration data, electrically connecting the signal source and the spectrum analyzer to the preselector, outputting a signal from the signal source into the preselector, measuring the difference between signals passing through a filtered path of the preselector and a bypass path of the preselector, and combining the difference measurement with the bypass calibration data to calibrate the filtered path of the preselector, are performed over a range of frequencies.

20. The method of claim 19, wherein the range of frequencies includes frequencies in the range from 9 kHz to 1 GHz.
